(19) United States
(12) Patent Application Publication
(10) Pub. No.: US 2005/0190433 A1
(43) Pub. Date: Sep. 1, 2005

(54) Optical fiber and hybrid optical amplifier using the same

(76) Inventors: Hong Seok Seo, Daejeon-Shi (KR); Yong Gyu Choi, Daejeon-Shi (KR); Kyong Hon Kim, Daejeon-Shi (KR); Bong Je Park, Daejeon-Shi (KR); Doo Hee Cho, Daejeon-Shi (KR)

Correspondence Address: YOON HAM, PIPER RUDNICK LLP, P.O. BOX 9271, RESTON, VA, 20195, US

(21) Appl. No.: 10/929,720

(22) Filed: Aug. 31, 2004

(30) Foreign Application Priority Data
Feb. 26, 2004 (KR) 2004-13209

(51) Int. Cl. H01S 3/00

(52) U.S. Cl. 359/341.1

(57) ABSTRACT

Provided are an optical fiber that prevents optical amplification bands from overlapping each other while enabling optical signal amplification by a rare-earth element and optical signal amplification by a nonlinear Raman effect to simultaneously occur by performing a pumping operation using a single-wavelength light source, and a hybrid optical amplifier using the same. The optical fiber includes: a clad; and a core configured to have a refractive index larger than that of the clad, the core including a first element doped to receive pumped light having a predetermined wavelength and optically amplify the received signal light into a first band using a rare-earth element, and a second element doped to optically amplify the received signal light using nonlinear Raman optical amplification into a second band.

### BACKGROUND

1. Field of the Invention

The present invention relates to an optical fiber and a hybrid optical amplifier using the same and, more particularly, to an optical fiber that prevents each amplification band from being overlapped, while enabling optical signal amplification by a rare-earth element and optical signal amplification by a nonlinear Raman effect to simultaneously occur through pumping using a single-wavelength light source, and a hybrid optical amplifier using the same.

2. Discussion of Related Art

Generally, an erbium-doped optical fiber amplifier, a nonlinear Raman optical amplifier using a Raman phenomenon, a semiconductor optical amplifier, and the like have been developed as optical fiber amplifiers. Among them, the Raman optical amplifier and the erbium-doped optical fiber amplifier have been extensively studied as very important amplifiers for wavelength-division-multiplexing optical communication systems with the development of high-power semiconductor laser diodes.

The erbium-doped optical fiber amplifier is being primarily used as a C-band optical amplifier, and is also used as an L-band optical amplifier with a different structure for optical amplification. Such a way of simultaneously amplifying C-band and L-band signals is accomplished by connecting the C-band amplifier and the L-band amplifier to each other in parallel. However, there are problems that a plurality of optical devices are used for the amplifier and the entire structure thereof is somewhat complex.

The Raman amplifier can amplify band signals that can not be amplified by the erbium-doped optical fiber amplifier, because of its gain area variable with pumping wavelengths. Further, its gain bandwidth is extendable over 100 nm through a multiple-wavelength pumping operation. A distributed-type Raman amplifier, which utilizes a transmission medium itself as an amplification medium, has an advantage that a signal-to-noise ratio (SNR) is highly enhanced. However, there is a problem with the distributed-type Raman amplifier that it needs a nonlinear optical fiber medium of a long length for amplification, and also needs a plurality of high-power semiconductor lasers for C-band light amplification and for L-band light amplification, which have different wavelengths, in order to obtain a desired optical gain.

### SUMMARY OF THE INVENTION

The present invention is conceived to solve the aforementioned conventional problems. It is an objective of the present invention to enable optical signal amplification by a rare-earth element and optical signal amplification by a nonlinear Raman effect to simultaneously occur by pumping using a single-wavelength light source.

It is another objective of the present invention to implement an optical fiber for amplification that prevents an optical amplification band by a rare-earth element and an optical amplification band by Raman from overlapping each other, and a hybrid optical amplifier using the same.

It is yet another objective of the present invention to provide an optical fiber amplifier in which optimal gain flattening is obtained by analyzing a gain characteristic in dependence on a concentration of a rare-earth element (e.g., erbium) in a core and adjusting optical pumping power and the optical fiber length for a rare-earth amplification band and a Raman amplification band.

It is still another object of the present invention to provide an amplifier having a structure simpler than that of an optical amplifier configured by simultaneously connecting several bands to each other in parallel using a multi-wavelength pumping Raman optical amplifier and an erbium-doped optical fiber amplifier.

According to an aspect of the present invention for solving the aforementioned problems, there is provided an optical fiber, comprising: a clad; and a core configured to have a refractive index larger than that of the clad, the core including a first element doped to receive a pumping source having a predetermined wavelength and optically amplify the received signal light into a first band using a rare-earth element, and a second element doped to optically amplify the received signal light using nonlinear Raman optical amplification into a second band.

A term “optical fiber” used herein is a collectively called one having no particular limitation only if it performs a function of delivering light in a certain direction irrespective of the shape, medium, and the like of the optical fiber. It will be appreciated that it is a concept including all of optical waveguides and the like.

Preferably, when the optical fiber has a composition of silica, the predetermined pumping wavelength is a single wavelength having a band of 1480 to 1500 nm, C-band (1530 to 1570 nm) signals are amplified using optical amplification by erbium, and L-band (1570 to 1610 nm) signals are amplified using nonlinear Raman amplification by germanium. In this case, the erbium is doped in the core at a concentration of 10¹⁵ cm⁻³ to 10¹⁷ cm⁻³ and the germanium is doped at a concentration of 10 to 30 mol %, so that a refractive index difference between the core and the clad is 0.015 to 0.03.

According to another aspect of the present invention, there is provided a hybrid optical amplifier, comprising: an optical fiber, according to any one of claims 1 to 8, for receiving optical signals from an input stage, amplifying and delivering the received optical signals to an output stage; at least one light source for outputting pumped light to the optical fiber; and at least one coupler for coupling the optical signal and the pumped light output from the light source.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a schematic configuration diagram of an optical fiber according to a preferred embodiment of the present invention;

FIG. 2 is a schematic configuration diagram of a hybrid optical amplifier according to a preferred embodiment of the present invention;

FIG. 3 is a graph of out power to wavelength in an example in which a hybrid optical amplifier is subject to computer simulation according to a preferred embodiment of the present invention;

FIG. 4 illustrates a result of calculating gain variations when the length of an optical fiber for the optical amplifier of FIG. 3 is changed;

FIG. 5 is a graph showing gain variations obtained by adjusting pumping power in the optical amplifier of FIG. 3; and

FIG. 6 is a graph showing gain levels and noise characteristics for optimal lengths of the optical fiber and optimal pumping power when erbium concentration in a core of the optical amplifier of FIG. 3 is changed.

### DETAILED DESCRIPTION OF PREFERRED EMBODIMENTS

Hereinafter, embodiments of the present invention will be described in detail with reference to the accompanying drawings. FIG. 1 is a schematic configuration diagram of an optical fiber according to a preferred embodiment of the present invention. However, the embodiments of the present invention may be changed into several other forms, and it should not be construed that the scope of the present invention is limited to the embodiments described in detail below. The embodiments of the present invention are intended to explain the present invention more completely to those skilled in the art.

An optical fiber 1 comprises a clad 10; and a core 20 having a refractive index larger than that of the clad 10, the core 20 including a first element doped to receive light having a predetermined wavelength and to optically amplify the received light into a first band using a rare-earth element, and a second element doped to optically amplify the received light into a second band using nonlinear Raman optical amplification. Silica, tellurite, fluoride, or sulfide may be used as a composition of the optical fiber. Preferably, the first element (e.g., rare-earth element) is erbium, ytterbium, praseodymium, neodymium, holmium, thulium, or dysprosium, and the second element used for Raman amplification is silicon, germanium, phosphorus, sulfur, tellurium, or selenium, which constitutes a glass composition. Further, each of the first element and the second element may be used with one or more kinds of elements being doped.

For example, in case of an optical fiber using a silica element, the optical fiber may be pumped into a single wavelength having a band of 1480 to 1500 nm, and erbium may be used as the first element, and germanium may be used as the second element. That is, the optical fiber is made of the silica element, and the erbium and germanium elements are doped in a core portion. C-band (1530 to 1570 nm) signals may be amplified by optical amplification using the erbium, and L-band (1570 to 1610 nm) signals may be amplified by nonlinear Raman amplification of germanium. Preferably, the erbium is doped in the core 20 at a concentration of about 10¹⁵ cm⁻³ to 10¹⁷ cm⁻³, and the germanium is doped at a concentration of 10 to 30 mol %. Meanwhile, a cut-off wavelength may be 1.2 to 1.481 μm.

The Raman amplification is a typical nonlinear process that easily occurs in a germanium-silica optical fiber of a small core diameter at high optical pumping power, and amplifies optical signals at a wavelength shifted from the wavelength of a pumped light. Meanwhile, a typical erbium-doped optical fiber amplifier will need an optical fiber having a length in the order of 10 m to amplify C-band optical signals over 30 dB, and the Raman amplifier will need an optical fiber having a length in the order of a few km to amplify the optical signal at the same condition.

For example, a distributed type of erbium-doped optical fiber having a length of 5 km has a proper erbium concentration in the core to maintain a proper inversion ratio over the entire length, which allows to amplify C-band signals over 20 dB. In the case where the optical fiber has a high germanium concentration in the core, which makes a difference of the refractive index of 0.015 between the core and the cladding and a cut-off wavelength of 1.41 μm, pumping the optical fiber with a high-power laser diode operated at a wavelength of 1.495 μm causes the erbium ions of a low concentration in the core to be excited into a high level by the pumping power. However, the pumping power that is not absorbed by the erbium ions causes Stimulated Raman Scattering (SRS) in the core. It results in a Raman gain peak at 1.60 μm. The gain level over the C-band and the L-band depends on the erbium and Ge concentrations, optical fiber lengths, optical losses, pumping powers, and the like.

Since the erbium concentration in the silica optical fiber results in C-band optical amplification within a few km of the same length, it is preferable to dope the erbium at a concentration of about one in a few hundreds (10¹⁵ to 10¹⁷ cm⁻³) of a generally used existing erbium-doped optical fiber. Further, if a germanium concentration is between 10 mol % and 30 mol %, a refractive index difference between the core and the clad is in the order of 0.015 to 0.03, resulting in sufficient Raman optical amplification over a length of 1-10 km.

If the optical fiber made in this manner is pumped by a high-power semiconductor laser having a wavelength of 1.495 μm, the C-band optical signals are amplified by the erbium, and a pumped remaining light, not absorbed by the erbium, is utilized in the Raman optical amplification so that L-band optical signals are optically amplified at a band of 1.60 μm corresponding to a Raman transition of the pumped light. The size of the gain obtained in the C- and L-bands sensitively varies with the erbium and germanium concentrations in the core, optical fiber structures, optical fiber lengths, optical losses, pumping powers, an effective sectional area of the core, and the like. If the fiber length and the pumping power are adjusted for gain flattening, it can result in the gain flattening within 5 dB.

Concentration of the erbium in the optical fiber core should have an optimal concentration value in order to obtain a flat gain between the C-band and the L-band. Too high concentration of the erbium causes all C-band optical signals to be absorbed by unexcited erbium ions and the L-band optical signals not to be amplified due to low power of the pumped light. Preferably, the erbium is doped in the core at a concentration ranging from 10¹⁵ to 10¹⁷ cm⁻³. Too low concentration of the erbium causes the L-band optical signals to be more strongly amplified compared with the C-band optical signals.

Meanwhile, if the optical fiber has a composition of tellurite, it may pump light into a single-wavelength having a band of 1470 to 1500 nm, and allows a configuration such that L-band (1570 to 1610 nm) signals are amplified using the optical amplification by the tellurite and U-band (1610 to 1700 nm) signals are amplified using the nonlinear Raman amplification of germanium.

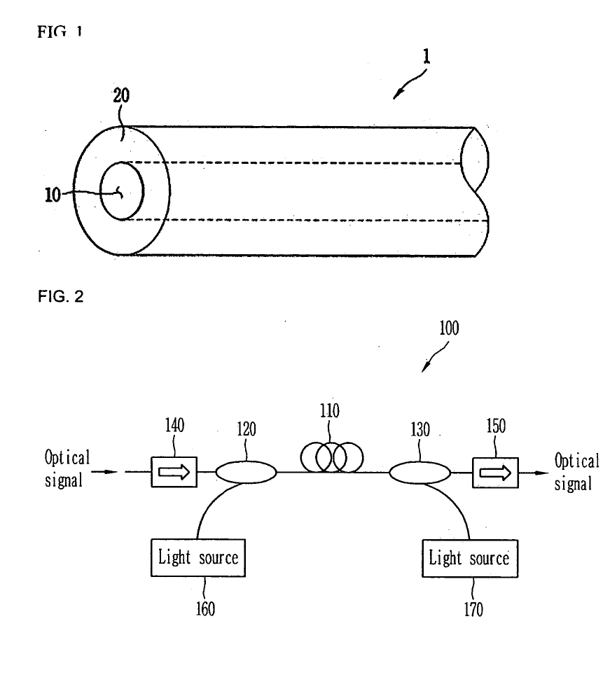

FIG. 2 is a schematic configuration diagram of a hybrid optical amplifier according to a preferred embodiment of the present invention.

A hybrid optical amplifier 100 includes first and second isolators 140 and 150, an erbium/silicon-doped optical fiber 110, first and second couplers 120 and 130, and first and second light sources 160 and 170.

The first isolator 140 serves to pass an optical signal, which is input to the optical amplifier, as it is and block a light input in a reverse direction. The second isolator 150 serves to pass light input via the second coupler 130 and block a reflected optical signals in a reverse direction.

The erbium/germanium-doped silica optical fiber 110 includes a first element doped to receive pumped light having a predetermined wavelength and optically amplify the received signal light into a first band using a rare-earth element; and a second element doped to optically amplify the received signal light into a second band using nonlinear Raman optical amplification. As previously described, such an optical fiber may pump the light into a single wavelength having a band of 1480 to 1500 nm, and amplify the C-band (1530 to 1570 nm) signals using optical amplification by the erbium, and the L-band (1570 to 1610 nm) signals using nonlinear Raman amplification of the germanium, respectively.

The first and second light sources 160 and 170 are laser diodes that pump the light into a single wavelength having a band from 1480 to 1500 nm for example, and output the pumped light to the erbium/germanium-doped optical fiber 110.

The first coupler 120 functions to combine the optical signal progressing through the first isolator 140 and the light output from the first light source 160 and input the combined signal to the erbium/silicon-doped optical fiber 110. The second coupler 130 functions to pass the optical signal and to input the pumping beam, received from the second light source 170, to the erbium/silicon-doped optical fiber 110 in a reverse direction.

Meanwhile, although this embodiment has a structure in which the two light sources and the two WDM couplers are utilized, it may have a modified structure in which one light source and one WDM coupler are employed only for one of two sides of the erbium/silicon-doped optical fiber 110.

(Computer Simulation)

Next, computer simulation was carried out on the hybrid optical amplifier according to a preferred embodiment of the present invention. A tunable laser source (TLS) is connected to an input of the optical amplifier and an optical spectrum analyzer (OSA) is connected to an output of the optical amplifier. The input-light signal source, TLS, and a pumping laser diode are connected to the optical fiber subject to limitation by the WDM coupler. A wavelength of the pumping laser diode is fixed at an optimal wavelength, 1.495 μm, so that C-band optical amplification and L-band Raman optical amplification are simultaneously performed. The optical signal, input from the TLS, has input channels formed at 1 nm intervals between 1.53 and 1.61 μm. Both erbium and germanium have been doped in the optical fiber (see FIG. 2).

C-band optical signals are amplified by stimulated emission of the erbium inverted by absorbing the pumped light, and L-band optical signals are subject to Raman optical amplification at an L-band shifted by 440 cm⁻¹ of the pumped light wavelength.

Detailed numerical used for the computer simulation will be revealed. The erbium concentration was fixed at 3×10¹⁶ cm⁻³, Raman gain efficiency at 2.5 W⁻¹km⁻¹, a diameter of the core at 5.2 μm, and a cut-off wavelength at 1.41 μm. And, a refractive index difference was fixed at 0.015, germanium concentration at 10 mol %, an effective area at 28.51 μm², a length of the optical fiber at 5 km, and a background loss of the optical fiber at 1 dB/km. The length of the optical fiber as used, with both the erbium and the germanium being doped, is enough longer than that of a typically used erbium-doped optical fiber amplifier but is shorter than that of a distributed-type erbium-doped optical fiber amplifier.

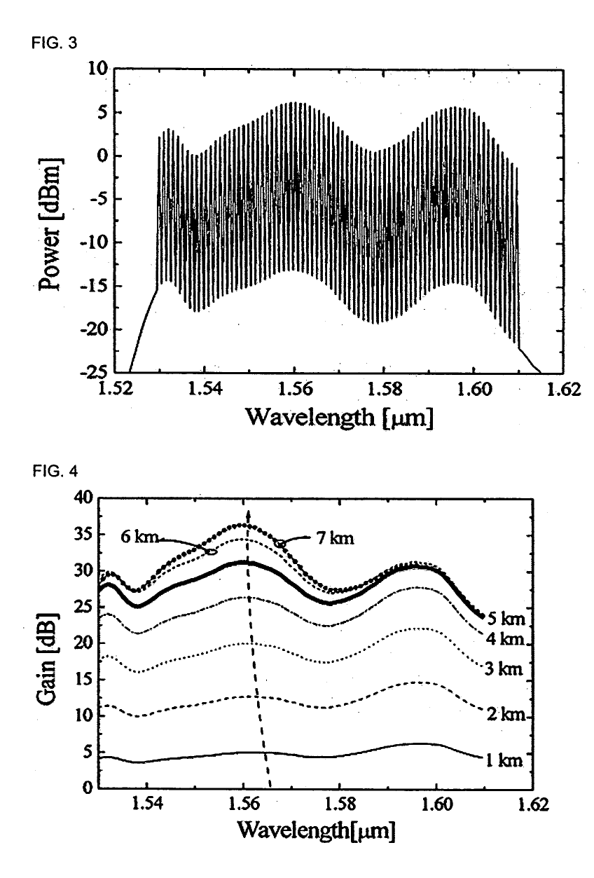

FIG. 3 is a graph of output powers for wavelengths in the optical amplifier that is computer-simulated at the above-stated condition. An output, which is obtained by amplifying an optical signal input in a uniform level of −25 dBm for each channel, is denoted on a wavelength axis. Each of forward and backward pumping powers as used is 600 mW, the length of the optical fiber is 5 km, and the concentration of the erbium is 3×10¹⁶ cm⁻³. Three peaks are shown at wavelengths of 1.53 m, 1.56 m and 1.60 μm, as shown in FIG. 3. The first peak is a direct transition peak of typical erbium, and the third peak is a gain peak by the Raman. The second peak is one caused by further increasing the optical signal, which has been amplified by the erbium, by means of Raman. Therefore, it can be seen that it is important to adjust the length of the optical fiber and the pumping power for an optimal condition for obtaining a flat gain band from 1.53 to 1.61 μm.

FIG. 4 shows a result of gain variations calculated upon changing the length of the optical fiber for the optical amplifier that is computer-simulated at the above-stated condition. In this case, an optical signal input in a uniform level of −25 dBm for each channel is amplified, each of forward and backward pumping powers as used is 600 mW, and the concentration of the erbium is 3×10¹⁶ cm⁻³.

If the length of the optical fiber is increased, all gain values gradually increase and the band of 1.56 μm, which is the second peak, gradually increases. This occurs by means of the gain shifting from erbium ions with low inversion due to exhausted pumping power resulting from the long length of the optical fiber. Accordingly, for gain flattening, it is desirable to fit the second peak to the first peak by adjusting the length of the optical fiber. In other words, because the second peak is related to the number of the erbium ions in the optical fiber, it suffices to adjust an optimal length of the optical fiber according to the erbium concentration in the optical fiber.

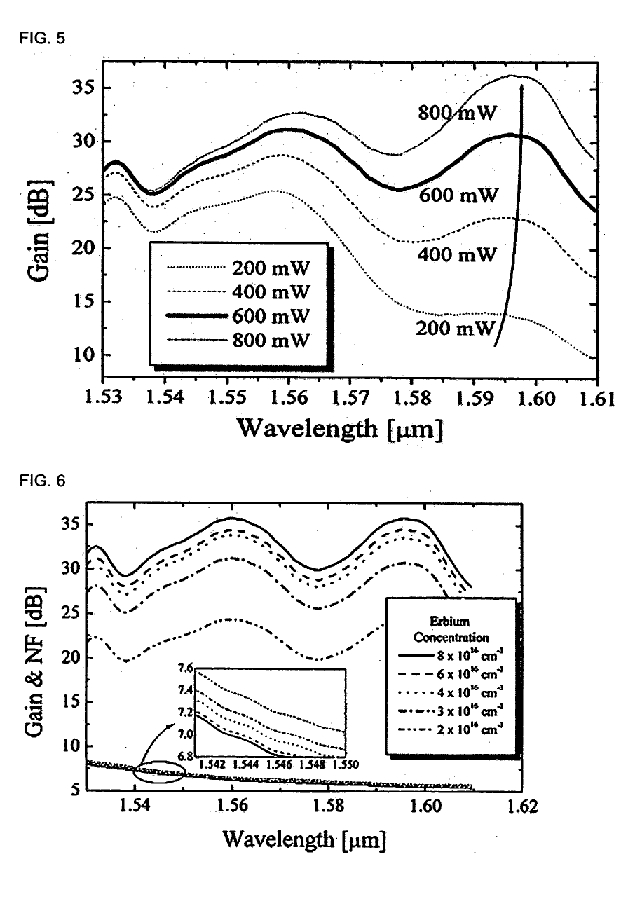

FIG. 5 is a graph showing a change of gain obtained by adjusting pumping power of the optical amplifier that is computer-simulated at the above-stated condition. In this case, an optical signal input in a uniform level of −25 dBm for each channel is amplified, forward and backward pumping powers as used are 200, 400, 600 and 800 mW, respectively, and the concentration of the erbium is 3×10¹⁶ cm⁻³. The length of the optical fiber is fixed at 5 km. The third peak (1.60 μm) is gradually increasing by an increase of the Raman gain with increasing the pumping power. The second peak is also slightly increasing due to obtained Raman gain along with the increase of the pumping power. Accordingly, the second peak may be controlled by adjusting the length of the optical fiber, and the third peak may be fitted to the first peak by adjusting the pumping power.

FIG. 6 is a diagram showing gain levels and noise characteristics for optimal lengths of the optical fiber and pumping power upon changing the concentration of the erbium in the core of the optical amplifier that is computer-simulated at the above-stated condition.

When the Erbium concentration is 8×10¹⁶ cm⁻³, the optimal length of the optical fiber and the pumping power for gain flattening were about 2 km and about 1.4 W, respectively. At this condition, an average gain of 32 dB, was obtained and noise ranging from 5.36 to 8.0 dB was obtained. The remaining pumping power, not absorbed over the overall length of the optical fiber, is 450 mW. In case of such an optical fiber with erbium being doped at a high concentration, an optical fiber having a short length is required to be used for fitting the second peak to the first peak, and it results in insufficient nonlinear Raman gain, which in turn requires high pumping power for gain flattening at the third peak.

Further, when the erbium concentration was 2×10¹⁶ cm⁻³, the optimal length of the optical fiber and the pumping power were 6 km and 400 mW, respectively, the average gain was 22 dB, and the noise was between 5.78 and 8.2 dB. The remaining pumping power of 100 mW, not absorbed, was obtained. In case of the optical fiber with erbium being doped at a low concentration, gain flattening is obtained even with low pumping power because an optical fiber having a long length is utilized. As a result, an optical fiber with erbium being doped at a high concentration has a high gain and a low noise characteristic but is inefficient because of very high required pumping power, resulting in inefficiency. On the other hand, the optical fiber with erbium being doped at a low concentration is efficient because it uses low pumping power even though it requires a long length. Further adjusting the concentration of the germanium allows the length of the optical fiber to be efficiently reduced and the pumping power to be also decreased, resulting in a more efficient amplifier configuration.

Although the present invention has been described in detail by way of the detailed embodiments, the present invention is not limited to the embodiments, and it will be apparent that variations and modifications may be made to the present invention by those skilled in the art without departing from the technical spirit of the present invention.

As described above, according to the present invention, there is an advantage that an optical amplification medium and an optical amplifier with a broad gain band using the same may be provided by causing optical signal amplification by a rare-earth element and optical signal amplification by a nonlinear Raman effect to simultaneously occur by performing a pumping operation using a light source with a single-wavelength, so that respective amplification bands do not overlap each other.

Further, it is possible to simultaneously amplify C-band signals and L-band signals with a simpler structure compared with a commercially used current erbium-doped optical amplifier, and there is no need for tying, as a unity, high-power multiple-wavelength pumping lasers used by a conventional Raman optical amplifier to simultaneously amplify the C-band signals and L-band signals, thereby simplifying the structure and lowering the cost.

1. An optical fiber comprising:
a clad; and
a core configured to have a refractive index larger than that of the clad, the core including a first element doped to receive pumped light having a predetermined wavelength and optically amplify the received signal light into a first band using a rare-earth element, and a second element doped to optically amplify the received signal light using nonlinear Raman optical amplification into a second band.

2. The optical fiber according to claim 1, wherein the optical fiber has a composition that is one of silica, tellurite, fluoride, sulfide, and selenide series.

3. The optical fiber according to claim 1, wherein the first element is one selected from a group consisting of erbium, ytterbium, praseodymium, neodymium, holmium, thulium, and dysprosium, and the second element is one selected from a group consisting of silicon, germanium, phosphorus, sulfur, tellurium, and selenium, which constitute a glass composition.

4. The optical fiber according to claim 1, wherein when the optical fiber has a composition of silica, the predetermined pumping wavelength is a single wavelength having a band of 1480 to 1500 nm, C-band (1530 to 1570 nm) signals are amplified using optical amplification by erbium, and L-band (1570 to 1610 nm) signals are amplified using nonlinear Raman amplification by the germanium.

5. The optical fiber according to claim 4, wherein the erbium is doped in the core at a concentration of 10¹⁵ cm⁻³ to 10¹⁷ cm⁻³ and the germanium is doped at a concentration of 10 to 30 mol %, so that a refractive index difference between the core and the clad is 0.015 to 0.03.

6. The optical fiber according to claim 1, wherein the optical fiber has a length of 1 to 10 km.

7. The optical fiber according to claim 1, wherein when the optical fiber has a composition of tellurite, the predetermined pumping wavelength is a single wavelength having a band of 1470 to 1500 nm, L-band (1570 to 1610 nm) signals are amplified using optical amplification by erbium, and U-band (1610 to 1700 nm) signals are amplified using nonlinear Raman amplification by tellurite.

8. The optical fiber according to claim 1, wherein the first gain band and the second gain band do not overlap each other.

9. A hybrid optical amplifier comprising:
an optical fiber for receiving an optical signal from an input stage, amplifying and delivering the received optical signal to an output stage, the optical fiber comprising a clad; and a core configured to have a refractive index larger than that of the clad, the core including a first element doped to receive pumped light having a predetermined wavelength and optically amplify the received signal light into a first band using a rare-earth element, and a second element doped to optically amplify the received signal light using nonlinear Raman optical amplification into a second band;
at least one light source for outputting pumped light to the optical fiber; and
at least one coupler for coupling the optical signal and the pumped light output from the light source.

10. The hybrid optical amplifier according to claim 9, wherein the light source and the coupler are present at each of the input stage and the output stage.

11. The hybrid optical amplifier according to claim 10, further comprising:
a first isolator disposed at the front of the coupler at the input stage, the first isolator passing the optical signal, input from the input stage, as it is and blocking light input in a reverse direction; and
a second isolator disposed at the rear of the coupler at the output stage, the second isolator passing the output optical signal as it is and blocking light input in a reverse direction.

12. The hybrid optical amplifier according to claim 9, wherein the optical fiber has a composition that is one of silica, tellurite, fluoride, sulfide, and selenide series.

13. The hybrid optical amplifier according to claim 9, wherein the first element is one selected from a group consisting of erbium, ytterbium, praseodymium, neodymium, holmium, thulium, and dysprosium, and the second element is one selected from a group consisting of silicon, germanium, phosphorus, sulfur, tellurium, and selenium, which constitute a glass composition.

14. The hybrid optical amplifier according to claim 9, wherein when the optical fiber has a composition of silica, the predetermined pumping wavelength is a single wavelength having a band of 1480 to 1500 nm, C-band (1530 to 1570 nm) signals are amplified using optical amplification by erbium, and L-band (1570 to 1610 nm) signals are amplified using nonlinear Raman amplification by the germanium.

15. The hybrid optical amplifier according to claim 14, wherein the erbium is doped in the core at a concentration of 10¹⁵ cm⁻³ to 10¹⁷ cm⁻³ and the germanium is doped at a concentration of 10 to 30 mol %, so that a refractive index difference between the core and the clad is 0.015 to 0.03.

16. The hybrid optical amplifier according to claim 9, wherein the optical fiber has a length of 1 to 10 km.

17. The hybrid optical amplifier according to claim 9, wherein when the optical fiber has a composition of tellurite, the predetermined pumping wavelength is a single wavelength having a band of 1470 to 1500 nm, L-band (1570 to 1610 nm) signals are amplified using optical amplification by erbium, and U-band (1610 to 1700 nm) signals are amplified using nonlinear Raman amplification by tellurite.

18. The hybrid optical amplifier according to claim 9, wherein the first gain band and the second gain band do not overlap each other.
